(19) United States
(12) Patent Application Publication
(10) Pub. No.: US 2019/0110431 A1
(43) Pub. Date: Apr. 18, 2019

(54) PET BOX WITH STAIR STRUCTURE

(71) Applicant: HUI CHU LAICHENG, Taichung (TW)

(72) Inventor: HUI CHU LAICHENG, Taichung (TW)

(21) Appl. No.: 15/787,329

(22) Filed: Oct. 18, 2017

(51) Int. Cl. A01K 1/02

(52) U.S. Cl. CPC A01K 1/0245

(57) ABSTRACT

A pet box includes a box member having a room therein and an entrance communicated with the room, and a stair member connected to the box member. Therefore, pets could get into and get off the room through the stair member without its host's help.

### BACKGROUND OF THE INVENTION

### 1. Technical Field

The present invention relates to an appliance for pets, and more particularly to a pet box with a stair structure.

### 2. Description of Related Art

Conventional pet boxes are provided with a handle for a user to carry the pet box, so that the conventional pet boxes had to be made with a small size in order to reduce the weight thereof. It is easy to understand that small pet box only receive small pet therein, and sometime the pet has to prostrate itself in the pet box.

Pet strollers are a solution for use to carry large pets. Usually, the pet is unable to get up the stroller and off the stroller by itself, it needs man to carry the pet on the stroller and off the stroller.

Some conventional pet strollers only have short walls. The advantage of the short walls is that people may see the pet, and the disadvantage is that pet may jump off the stroller unexpectedly.

### BRIEF SUMMARY OF THE INVENTION

In view of the above, the primary objective of the present invention is to provide a pet box, which provides an easy way for pets to get in and get off without man's help.

The secondary objective of the present invention is to provide a pet box, which provides an easy way for storage, and has a good storing space.

In order to achieve the objective of the present invention, a pet box includes a box member having a room therein and an entrance communicated with the room, and a stair member connected to the box member.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of a first preferred embodiment of the present invention;

FIG. 2 is a perspective view of a second preferred embodiment of the present invention;

FIG. 3 is an exploded view of the second preferred embodiment of the present invention;

FIG. 4 is a sectional view of the second preferred embodiment of the present invention;

FIG. 5 is an exploded view of a third preferred embodiment of the present invention; and

FIG. 6 is a perspective view of the third preferred embodiment of the present invention.

### DETAILED DESCRIPTION OF THE INVENTION

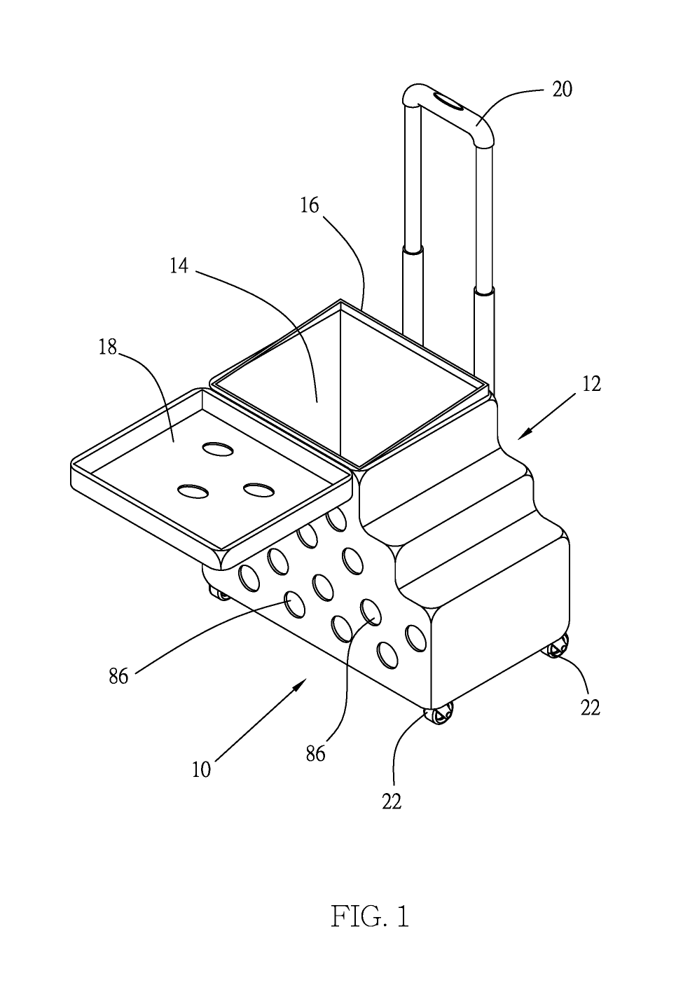

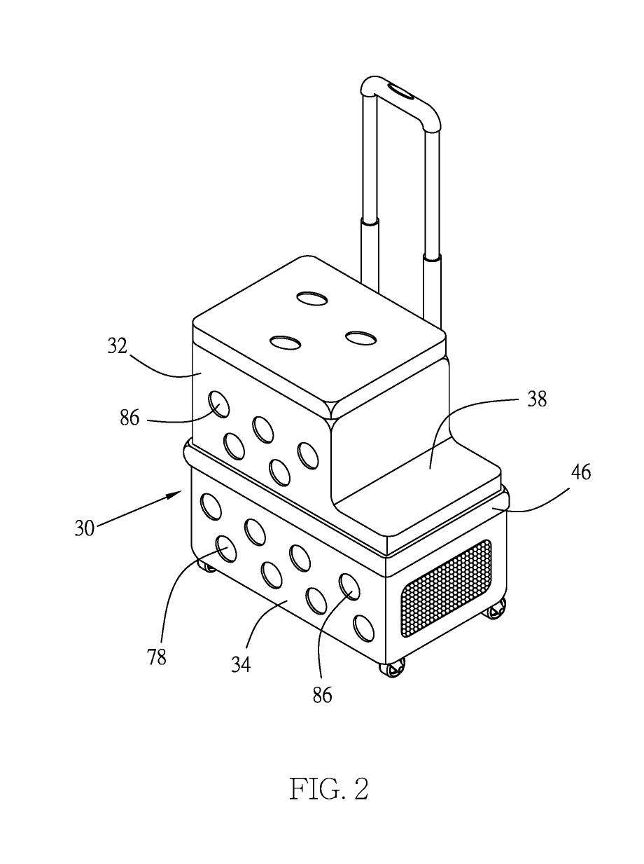

As shown in FIGS. 1 and 2, a pet box of the first preferred embodiment of the present invention includes a box member 10 and a stair member 12 connected to the box member 10. The stair member 12 has at least a tread. The box member 10 has a room 14 therein and an entrance 16 on a top thereof communicated with the room 14. The entrance 16 is inclined, and the stair member 12 has a riser adjacent to a lower side of the entrance 16. A lid 18 is pivoted on the box member 10 to open and close the entrance 16. A handle 20 is connected to the box member 10, and a plurality of wheels 22 are provided on a bottom of the box member 10 that makes the pet box of the present invention a pet stroller.

A pet may step on the tread of the stair member 12 to the opening 16 of the box member 10, and then jump into the room 14 through the opening 16 by itself. Then, user may hold the handle to draw the pet stroller to move.

In an embodiment, the pet box of the present invention only has the box member and the stair member that make the pet box a pet nest. The pet nest still allows a pet get into and out of the box member by itself.

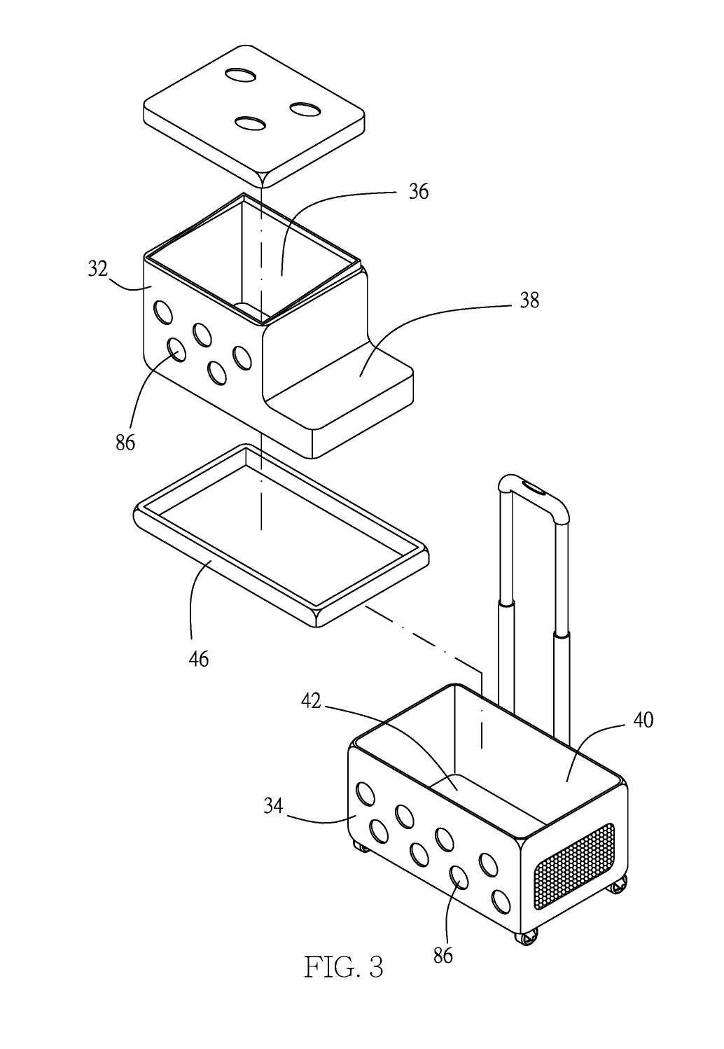

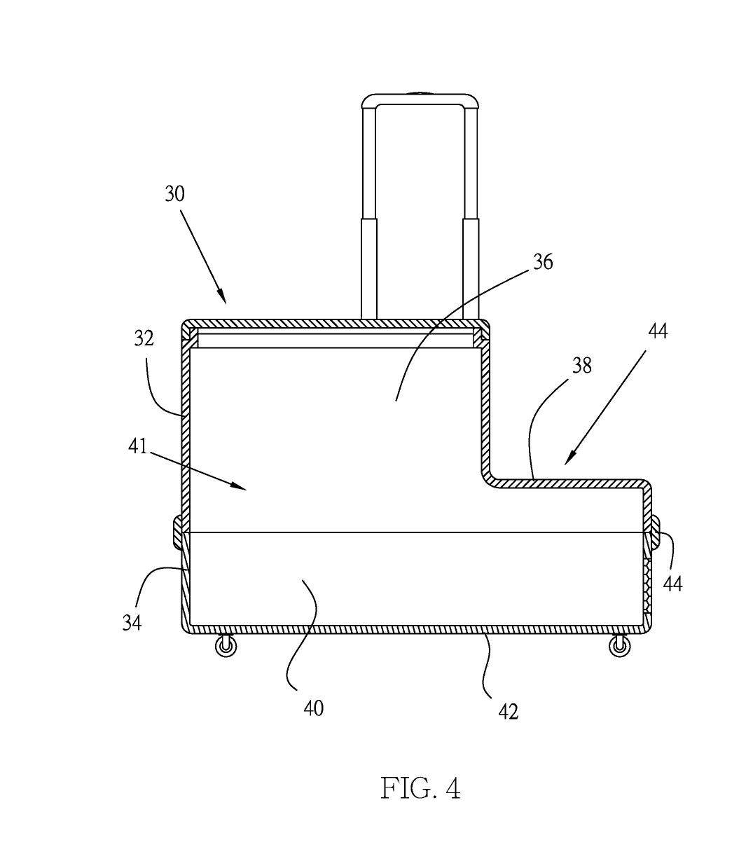

As shown in FIGS. 2, 3, and 4, a pet box of the second preferred embodiment of the present invention includes a box member 30, having a first box portion 32 and a second box portion 34. The first box portion 32 has a first space 36 (FIG. 3), which is opened at a top and a bottom of the first box portion 32, and a stepped portion 38 at a side thereof. The second box portion 34 has a second space 40, which is opened at a top of the second box portion 34 and closed at a bottom 42 thereof.

The first box portion 32 is put on the second box portion 34 and connected thereto through a connector 46 to form the box member 30 while the first space 36 is communicated with the second space 40 to form a room 41, and the stepped portion 38 is rested on the second box portion 34 to form a stair member 44. In the present embodiment, the connector 46 is a ring fitted to a junction of the first and the second box portions 32 and 34. In another embodiment, the connector 46 could be a zip, a clip, or other equivalent devices.

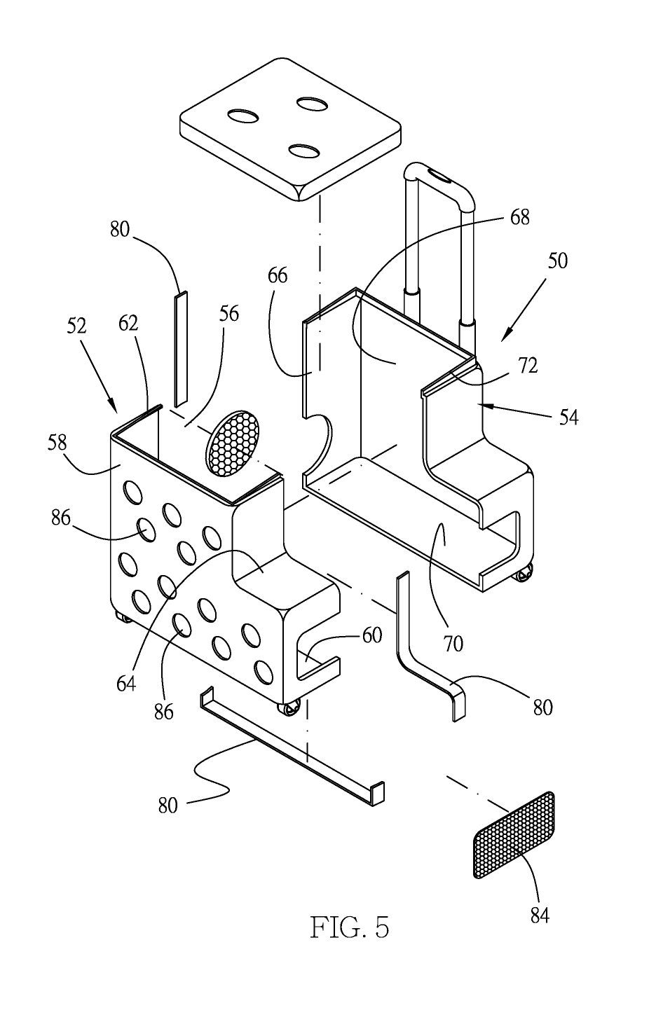

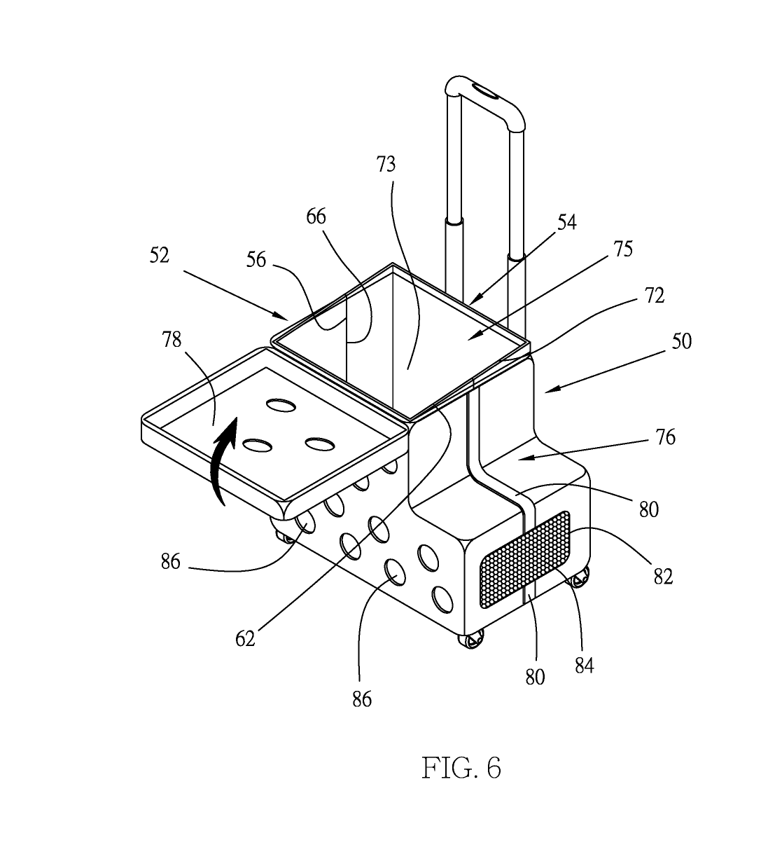

As shown in FIGS. 5 and 6, a pet box of the third preferred embodiment of the present invention includes a box member 50, having a first box portion 52 and a second box portion 54.

The first box portion 52 has a first open side 56, a first sidewall 58, a first bottom 60, and a first top opening 62. The first sidewall 58 further has a first stepped portion 64 adjacent to the first open side 56 and the first bottom 60.

Complementary to the first box portion 52, the second box portion 54 has a second open side 66, a second sidewall 68, a second bottom 70, and a second top opening 72. The second sidewall 68 further has a second stepped portion 74 adjacent to the second open side 66 and the second bottom 70.

The first box portion 52 is connected to the second box portion 54 with the first open side 56 aligned with the second open side 66 to form the box member 50 with a room 73 therein. The first top opening 62 is connected to the second top opening 72 to form an entrance 75 of the room 73. The first stepped portion 64 is connected to the second stepped portion 74 to form a stair member 76. The pet box of the third preferred embodiment further includes a lid 78 connected to the box member 50 to close the entrance 75.

In the third preferred embodiment, at least a connector 80 is provided to secure the first and the second box portions 52 and 54. The connector 80 could be a ring, a clip, a zip, or other equivalent devices.

Furthermore, the box member 50 is provided with a window 82, a half on the first sidewall 58 and a half on the second sidewall 68. The window 82 is on a riser of the stair member 76. A porous member 84, such a screen, is provided in the window. The box member 50 further is provided with a plurality of bores 86 communicated with the room 73.

The window and the bores could be provided on each of the box members of the pet box of the preferred embodiments of the present invention. The lid could be made of a porous member, such as a screen, which is helpful to the ventilation of the room. Furthermore, the box member could be a single member without the connector.

With the designs above, pet could get in or get out of the room of the pet box through the stair member without the help of host.

It must be pointed out that the embodiments described above are only some preferred embodiments of the present invention. All equivalent structures which employ the concepts disclosed in this specification and the appended claims should fall within the scope of the present invention.

What is claimed is:

1. A pet box, comprising:
a box member having a room therein and an entrance communicated with the room; and
a stair member connected to the box member.

2. The pet box of claim 1, wherein the entrance is on a top of the box member, and the stair member has a riser adjacent to the entrance of the box member.

3. The pet box of claim 2, further comprising a lid connected to the box member to close the entrance, and the entrance is inclined while the stair member has a riser adjacent to a lower side of the entrance.

4. The pet box of claim 1 wherein the box member has a first box portion and a second box portion; the first box portion has a first space, which is opened at a top and a bottom of the first box portion, and a stepped portion at a side thereof; the second box portion has a second space, which is opened at a top of the second box portion and closed at a bottom thereof; the first box portion is put on the second box portion and connected thereto to form the box member while the first space is communicated with the second space to form a room, and the stepped portion of the first box portion is rested on the second box portion to form a stair member.

5. The pet box of claim 4, further comprising a connector provided at a junction of the first and the second box portions to connect the first box portion to the second box portion.

6. The pet box of claim 1, wherein the box member has a first box portion and a second box portion; the first box portion has a first open side, a first sidewall, a first bottom, and a first top opening; the first sidewall further has a first stepped portion adjacent to the first open side and the first bottom; the second box portion has a second open side, a second sidewall, a second bottom, and a second top opening; the second sidewall further has a second stepped portion adjacent to the second open side and the second bottom; the first box portion is connected to the second box portion with the first open side aligned with the second open side to form the box member with the room therein; the first top opening is combined with the second top opening to form the entrance of the room; the first stepped portion is connected to the second stepped portion to form the stair member.

7. The pet box of claim 4, further comprising a connector provided at the first open side of the first box portion and the second open side of the second box portion to connect the first box portion to the second box portion.

8. The pet box of claim 6, wherein the box member is provided with a window; a part of the window is on the first box portion and the rest part of the window is on the second box portion.

9. The pet box of claim 6, wherein the box member is provided with a window; a part of the window is on the first box portion and the rest part of the window is on the second box portion.

10. The pet box of claim 1, wherein the box member is provided with a plurality of bores communicated with the room.
